(19) United States
(12) Patent Application Publication
(10) Pub. No.: US 2020/0311812 A1
(43) Pub. Date: Oct. 1, 2020

(54) BLOCKCHAIN-BASED REMITTANCE AND COLLECTION METHOD USING KEYWORD SEARCH AND SYSTEM USING THE SAME

(71) Applicants: Zae Young KIM, Seoul (KR); Spinor Media Inc., Seoul (KR)

(72) Inventor: Zae Young KIM, Seoul (KR)

(73) Assignees: Spinor Media Inc., Seoul (KR); Zae Young KIM, Seoul (KR)

(21) Appl. No.: 16/834,094

(22) Filed: Mar. 30, 2020

(30) Foreign Application Priority Data
Apr. 1, 2019 (KR) 10-2019-0037918

(51) Int. Cl. G06Q 40/04; G06Q 10/10; G06Q 20/36; G06Q 40/02; G06Q 20/40; G06Q 20/06; G06F 16/27; G06F 16/953; G06F 16/22; G10L 17/24

(52) U.S. Cl. CPC G06Q 40/04; G06Q 10/10; G06Q 20/3674; G06Q 40/02; G06Q 20/405; G06Q 2220/00; G06F 16/27; G06F 16/953; G06F 16/2246; G10L 17/24; G06Q 20/0655

(57) ABSTRACT

A blockchain-based remittance and collection system using keyword search includes: a remitter and collector node that executes a remitter and collector account including an address generator configured to generate an address and a metadata generator configured to generate metadata mapped to the address, and a verification node including an address mapping processor configured to map metadata to an address of the remitter and collector account, wherein the remitter and collector account is one of an electronic wallet and a smart contract.

### CROSS-REFERENCE TO RELATED APPLICATION

This application claims priority to Korean Patent Application No. 10-2019-0037918 filed on Apr. 1, 2019, the entire contents of which are herein incorporated by reference.

### BACKGROUND

### 1. Field

One or more embodiments relate to a method of implementing a blockchain-based remittance and collection platform using keyword search and a system using the blockchain-based remittance and collection platform, and more particularly, to a blockchain-based remittance and collection method, by which an electronic wallet address or a smart contract address is easily found through keyword search and which has user convenience, reliability, and security, and a system using the blockchain-based remittance and collection method.

### 2. Description of the Related Art

Bitcoin is the first generation of blockchain technology that introduces a peer-to-peer system of distributed ledgers, which is free from central server management through a new cryptocurrency. Ethereum, which provides a distributed computing platform for implementing smart contract functions based on blockchain technology, is the second generation of blockchain technology. Ether, which is provided by Ethereum, is traded as a kind of cryptocurrency in cyberspace, like Bitcoin, and is the most representative Altcoin and blockchain platform.

The blockchain platform has features that members (nodes) participating in the system may distribute and store data on their own computers, thereby making it virtually impossible to falsify the data (reliability) and the members may have their own distributed information (transparency) and there is no need for a central server administrator.

Cryptocurrency associated with the blockchain technology includes a user's information and encryption key for storing, sending/receiving and trading the cryptocurrency, and a blockchain-based electronic wallet is intended to implement such a function.

The blockchain-based wallet uses a public key in a public key cryptosystem as a bank account number and a corresponding private key as a password for the account.

In this case, when the complex hash function encryption of the public key and the private key is used as it is, a public key such as the user's address may not be easily searched or recognized by the other party, and thus the public has low transaction accessibility and difficulty.

Accordingly, there is a need for a blockchain-based remittance and collection platform that may easily find an electronic wallet address or a smart contract address through a keyword search function and may solve reliability and security problems that may occur due to the keyword search function.

### SUMMARY

One or more embodiments include a blockchain-based remittance and collection method, by which an electronic wallet address or a smart contract address is easily found through keyword search and which has user convenience, reliability, and security, and a system using the blockchain-based remittance and collection method.

One or more embodiments include a blockchain wallet platform that may easily find an electronic wallet address or a smart contract address through a keyword search function and may maintain the reliability of a search database.

One or more embodiments include contributing to related network activation by resolving information asymmetry and information gaps between collectors and remitters in a blockchain-based remittance and collection platform.

One or more embodiments include a blockchain-based remittance and collection method and system using keyword search, which may activate a remittance and collection network between music creators or related stakeholders and multinational fans, or between multinational fans.

The technical objectives of the embodiments are not limited to the above-mentioned contents, and other technical objectives not mentioned will be clearly understood from the following description.

Additional aspects will be set forth in part in the description which follows and, in part, will be apparent from the description, or may be learned by practice of the presented embodiments.

According to one or more embodiments, a blockchain-based remittance and collection system using keyword search includes a remitter and collector node that executes a remitter and collector account including an address generator configured to generate an address and a metadata generator configured to generate metadata mapped to the address, and a verification node including an address mapping processor configured to map metadata to an address of the remitter and collector account, wherein the remitter and collector account is one of an electronic wallet and a smart contract.

The verification node may further include a verification processor configured to verify whether a condition for mapping the metadata to the address of the remitter and collector account is satisfied, and a keyword search processor configured to search for an address of at least one remitter and collector account through keyword search.

The metadata may include at least one piece of hashtag information generated in association with the remitter and collector account.

The verification processor may map metadata to an account address of an official node through proof, and the verification of the official node may be based on a hierarchy structure.

The verification processor may determine whether to map information associated with the metadata of the official node to an account address of a nonofficial node based on whether a past transaction exists between the nonofficial node and the official node.

The verification node may further include a metadata display processor configured to display information associated with the metadata of the official node and information associated with metadata of a nonofficial node to be different from each other when keyword search of the address of the remitter and collector account is performed.

The blockchain-based remittance and collection system may further include a substitute remitter account designated in association with the remitter and collector account, wherein, when a substitute remittance is requested by the remitter and collector account, at least a portion of a remittance amount may be remitted from the substitute remitter account.

A password for the remitter and collector account may be set through recognition of a sound received through an inside of an ear in an earphone mounted on a user of the remitter and collector account.

### BRIEF DESCRIPTION OF THE DRAWINGS

These and/or other aspects will become apparent and more readily appreciated from the following description of the embodiments, taken in conjunction with the accompanying drawings in which:

FIG. 1 is a conceptual diagram of a blockchain-based remittance and collection system according to an embodiment;

FIG. 2 is a block diagram of a blockchain-based remittance and collection system using keyword search, according to an embodiment;

FIG. 3 is a diagram illustrating a method of verifying an official node and granting official metadata, according to an embodiment;

FIG. 4 is a diagram illustrating a method of verifying a nonofficial node and granting nonofficial metadata, according to an embodiment; and

FIG. 5 is a flowchart illustrating a method of performing a blockchain-based remittance and collection using keyword search, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

Hereinafter, the inventive concept will be described in detail with reference to the accompanying drawings so that those skilled in the art to which the inventive concept pertains may easily practice the embodiments. However, the inventive concept may be implemented in many different forms and is not limited to the embodiments described herein.

Terms used herein is for describing the embodiments and is not intended to limit the inventive concept. In this specification, a singular form also includes a plural form unless otherwise specified in phrases.

Terms such as “include” or “comprise” as used herein are not to be construed as necessarily including all of the various components, steps, operations, and/or elements described in the specification, some of which may not be included, or has to be construed as further including additional components, steps, operations, and/or elements.

Furthermore, terms including ordinal numbers such as first and second used in the inventive concept may be used to describe elements, but the elements should not be limited by the terms. The terms are only used to distinguish one element from other elements. In addition, in the description of the inventive concept, when it is determined that detailed descriptions of related known technologies may obscure the subject matter of the inventive concept, detailed descriptions thereof will be omitted.

In addition, components shown in the embodiments of the inventive concept are illustrated independently to indicate different characteristic functions, and do not mean that components are composed of separate hardware or one software component unit. That is, components may be listed for convenience of description, at least two components may be combined to form one component, or one component may be divided into a plurality of components to perform a function. Integrated or separated embodiments of the components are also included in the scope of the inventive concept without departing from the essence of the inventive concept.

Hereinafter, embodiments according to the inventive concept will be described in detail with reference to the accompanying drawings. The configuration of the inventive concept and the effects thereof will be clearly understood through the following detailed description.

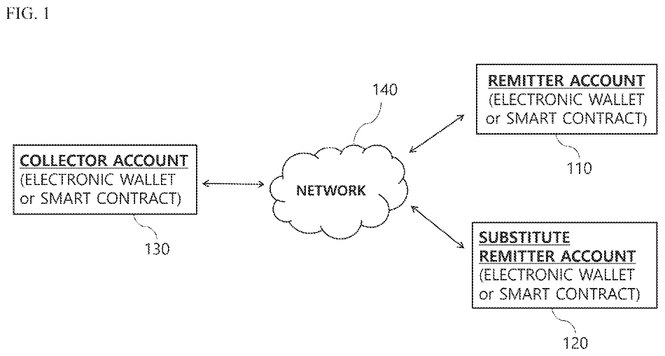

FIG. 1 is a conceptual diagram of a blockchain-based remittance and collection system according to an embodiment.

In a remitter account 110, a substitute remitter account 120, and a collector account 130, the account refers to the execution subject and basic unit of all trades or transactions and may be composed of an electronic wallet or a smart contract. In addition, the account may be divided into the remitter account 110, which is the subject of remittance, the substitute remitter account 120, which is the subject of substitute remittance, and the collector account 130, which is the subject of collection, according to a transaction role, and the role of the account may vary according to each transaction.

Each node that installs and executes the account may form a network of a peer-to-peer (P2P) structure that operates according to a blockchain algorithm through a network 140. The network 140 may be a wired or wireless network in various ways, for example, the Internet, one or more local area networks (LANs), a wide area network (WAN), a cellular network, a mobile network, and a low power wide area network (LPWAN).

in addition, as shown in FIG. 1, each of the remitter account 110, the substitute remitter account 120, and the collector account 130 may be composed of a smart contract. In this case, the smart contract refers to a digital contract that sets terms of a contract based on blockchain technology and fulfills the contract when the terms are met, and is a type of automated contract system. In a cryptocurrency, various benefits or contract terms contracted with an affiliate or related company may be stored in the form of a smart contract, and a user may apply a new contract term to the cryptocurrency in the electronic wallet to pay it to a counterpart.

For example, when transactions are conducted in accordance with a smart contract involving contents, music albums, concerts, etc., cryptocurrencies may be automatically delivered to composers, writers, sessions, and singers associated with the contract without any intervening interveners, based on predetermined rules. Even between smart contracts, remittances and collections may be automatically processed according to the set terms of the contract.

In addition, the blockchain-based remittance and collection system according to the embodiment includes the substitute remitter account 120 designated in association with the remitter account 110, and when a substitute remittance is requested by the remitter account 110, at least a portion of a remittance amount may be remitted from the substitute remitter account 120. In addition, when a substitute remittance is requested by the remitter account 110, the substitute remitter account 120 may select one of acceptance of the substitute remittance, rejection of the substitute remittance, and re-request such as a change of the remittance amount and deliver the selected one to the remitter account 110.

For example, when transacting through Ether that is a cryptocurrency used in Ethereum, when 10 Ethers need to be remitted to the collector account 130, the remitter account 110 may remit only 3 Ether, which is a remittable amount, and request to remit 7 Ether, which is an insufficient amount, through a designated substitute remitter account 120. The substitute remitter account 120 may be composed of two or more electronic wallets.

In the blockchain-based remittance and collection platform, when an electronic wallet address or a smart contract address may be easily found through keyword search, information asymmetry and information gap between a collector and a remitter may be resolved to contribute to the activation of related networks.

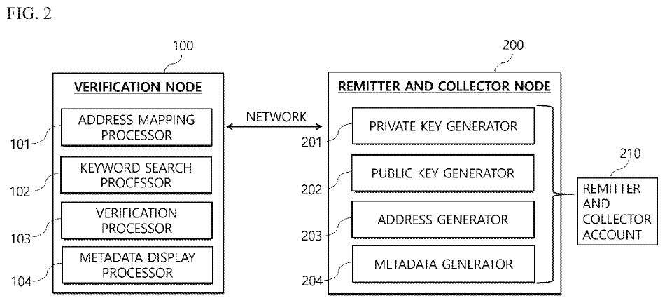

FIG. 2 is a block diagram of a blockchain-based remittance and collection system using keyword search, according to an embodiment. In FIG. 2, one verification node 100, one remitter and collector node 200, and one remitter and collector account 210 are illustrated for convenience of description. However, the blockchain-based remittance and collection system may include a plurality of remitter and collector nodes 200 and a plurality of remitter and collector accounts 210 respectively being in the plurality of remitter and collector nodes 200, and may include two or more verification nodes 100. In addition, the remitter and collector node 200 is a subject that executes the remitter and collector account 210, and may include at least one of various electronic devices or processing devices such as a computer, a smartphone, a tablet computer, a mobile communication device, and a computer server.

The verification node 100 may manage and verify a plurality of remitter and collector accounts 210 constituting a blockchain network where a keyword search is possible. As shown in FIG. 1 the remitter and collector account 210 may be a remitter account 110, a substitute remitter account 120, or a collector account 130, depending on the subject of the remittance or collection, and the role of the remitter and collector account 210 may vary depending on the type of remittance and collection transaction. The remitter and collector account 210 may be configured in the form of a smart contract.

First, the remitter and collector account 210 may include a private key generator 201 configured to generate and issue a private key, and a public key generator 202 configured to generate a public key generated through the private key. The pair of the private key and the public key generated in this way may be stored in the remitter and collector account 210. In this case, when the remitter and collector account 210 is in the form of a smart contract, the remitter and collector account 210 may not include the private key generator 201.

In addition, the remitter and collector account 210 may include an address generator 203 configured to hash the public key or otherwise generate a unique address for each account. For example, the address of an electronic wallet or smart contract on an Ethereum platform may be generated in a fixed array of 20 bytes.

In addition, the remitter and collector account 210 may include a metadata generator 204 configured to generate metadata mapped to or corresponding to the address thereof, and the metadata generated to be mapped to the address serves as an index, thereby enabling keyword search of the address of the remitter and collector account 210.

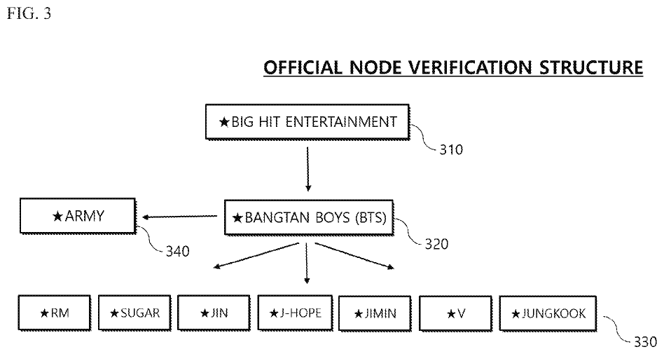

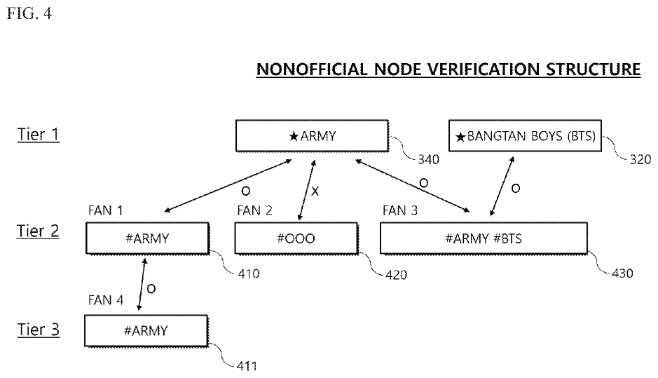

For example, the metadata may be attribute information provided by distinguishing an official node or a nonofficial node through proof in a blockchain system, at least one piece of hashtag information freely generated by the remitter and coil or account 210, or hashtag information related to attribute information of an official node selected in a nonofficial node. In this case, a hashtag is in a form of metadata for providing a convenient search function to easily find a specific topic or content in a social network service (SNS) or a micro blog, and is generally represented by a # sign and a specific word. The verification structure of the official node and the nonofficial node and a metadata display method will be described later with reference to FIGS. 3 and 4.

The verification node 100 may be composed of only a specific node approved among a plurality of nodes constituting the blockchain network, or may be composed of one or more nodes. Accordingly, all nodes do not need to participate in the verification, and thus the speed of management and verification processing is fast.

The verification node 100 may include an address mapping processor 101 configured to map metadata to the address of the remitter and collector account 210 and a keyword search processor 102 configured to search for the address of at least one electronic wallet through keyword search using metadata.

In addition, the verification node 100 may include a verification processor 103 configured to verify whether or not a condition for mapping the metadata to the address of the remitter and collector account 210 is satisfied. In this case, a verification method may use various conventional verification methods known in the art, for example, proof of work (PoW), proof of stake (PoS), and proof of concept (PoC). Since the metadata is mapped to the address of the remitter and collector account 210 after such a verification procedure, it is possible to improve the reliability of search information from the user's point of view.

In addition, the verification node 100 may further include a metadata display processor 104 that operates such that information associated with metadata of an official node and information associated with metadata of a nonofficial node are displayed differently from each other at the time of keyword search of the address of the remitter and collector account 210.

In accordance with the above-described address-metadata mapping process and different display process of metadata, metadata mapped to the address of the remitter and collector account 210 enables keyword search, and thus, the purpose of distinguishing an official node designated by verification from a general nonofficial node, as well as the purpose of quickly finding an address, may be achieved. Accordingly, a blockchain-based remittance and collection system using keyword search, which may maintain both convenience and reliability of user search, may be provided.

FIG. 3 is a diagram illustrating a method of verifying an official node and granting official metadata, according to an embodiment.

The official node refers to a node officially recognized or verified by a blockchain system. For example, in a blockchain network between a music creator and fans, as shown in FIG. 3, an entertainment agency, a belonging team or group, a belonging singer, an official fan club, and the like, which require search reliability, may be designated as official nodes to secure authenticity and reliability.

As illustrated in FIG. 3, verification of the official node may be performed based on a hierarchy structure. For example, the verification may proceed from a node 310 of Big Hit Entertainment, which is an entertainment agency, to a node 320 of Bangtan Boys (BTS) belonging to Big Entertainment, and from the node 320 of BTS to a node 330 of singers belonging to BTS or a node 340 of ARMY which is an official fan club, and thus metadata information mapped to an electronic wallet address of the official node may have a tree-like structure such as (entertainment agency)-(belonging group)-(belonging singer, official fan club).

When the verification processor 103 of the verification node 100 recognizes a node as an official node through verification, it is possible to map official metadata related to official name information to an electronic wallet address of the official node through the address mapping processor 101. Metadata information related to the official node is not freely generated in the official node, but is determined by consensus on the blockchain system.

In addition, as shown in FIG. 3, name or identification information corresponding to the electronic wallet address of the official node may be displayed together with a pre-promised mark, such as a star, in the front of the name to distinguish the official node from nonofficial nodes, and thus, such a distinctive display may provide authenticity and reliability when the user performs keyword search.

FIG. 4 is a diagram illustrating a method of verifying a nonofficial node and granting nonofficial metadata, according to an embodiment.

Referring to FIG. 4, a structure for verification between official nodes, e.g., the node 320 of BTS and the node 340 of ARMY, and nonofficial nodes, e.g., nodes 410, 420, and 430 of fans and verification between nonofficial nodes, e.g., a node 410 of a first fan FAN1 and a node 411 of a fourth fan FAN4, are shown. For example, the structure is represented as a hierarchical structure of three tiers.

In a first tier TIER 1, official nodes 320 and 340 associated with an official fan club or group may be located, and in a second tier TIER 2, nonofficial nodes 410, 420, and 430 composed of a plurality of fans may be located. In this case, the verification processor 103 of the verification node 100 may determine whether to map information associated with metadata of the official nodes 320 and 340 to the address of an electronic wallet of the nonofficial nodes 410, 420, and 430 based on whether there is a past transaction or activity between the nonofficial nodes 410, 420, and 430 and the official nodes 320 and 340. For example, when the node 410 of the first fan FAN1 has previously performed a transaction activity such as remittance and collection with the node 340 of ARMY, the node 410 of the first fan FAN1 may use a hashtag such as ‘# ARMY’ as metadata of an electronic wallet of the node 410 of the first fan FAN1. In addition, when the node 420 of the second fan FAN2 has previously not performed a transaction activity such as remittance and collection with the node 340 of ARMY, the node 420 of the second fan FAN2 may use a hashtag, which is arbitrarily designated and may identify the node 420, as metadata of an electronic wallet of the node 420 of the second fan FAN2, but may not use, as a hashtag, ‘# ARMY’ that is the same as the metadata of the node 340 of ARMY which is an official node.

In addition, since the node 430 of the third fan FAN3 has previously performed a transaction activity with both the node 340 of ARMY and the node 320 of BTS, the node 430 of the third fan FAN3 may map a hashtag of the same name as metadata of the two official nodes, for example, ‘# ARMY’ and ‘# BTS’, to metadata of the node 430. That is, metadata may be generated by mapping a plurality of hashtags or attribute information to each node.

In addition, when the node 411 of the fourth fan FAN4 located in a third tier TIER 3 has not performed a transaction activity with both the node 340 of ARMY and the node 320 of BTS, which are official nodes, but has performed a transaction activity with the node 410 of the first fan FAN1 of the second tier TIER 2, the node 411 of the fourth fan FAN4 may use the same metadata as ‘# ARMY’ which is the metadata of the electronic wallet of the node 410 of the first fan FAN1. That is, even a nonofficial node that does not have a direct transaction activity with an official node may use, as metadata, information associated with metadata of an official node according to whether there is a transaction activity with a nonofficial node having a transaction activity with the official node.

As such, by mapping the address of an electronic wallet to metadata to enable keyword search, a blockchain-based network may be activated between a music creator and fans or between multinational fans. In addition, as shown in FIG. 4, in order to display information related to metadata of the official nodes 320 and 340, a star is displayed in the front of the names of the official nodes 320 and 340, and in order to display information related to metadata of the nonofficial nodes 410, 411, 420, and 430, # (hashtag) different from the star is displayed in the front of the names of the nonofficial nodes 410, 411, 420, and 430. Thus, reliability of official nodes may be maintained.

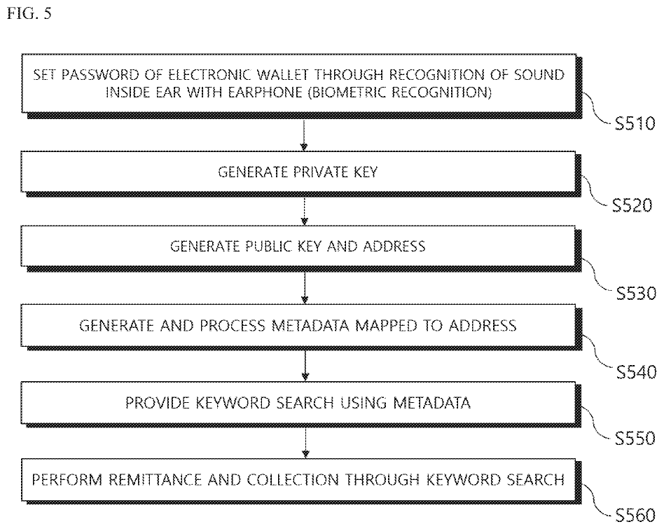

FIG. 5 is a flowchart illustrating a method of performing a blockchain-based remittance and collection using keyword search, according to an embodiment.

According to the embodiment, in order to enhance a security function, in a process of generating a private key, a password of an electronic wallet may be set through the recognition of sound inside the ear with an earphone (Operation S510). As the user does not receive a voice signal through an external microphone, but recognizes a voice signal transmitted to the inside of the ear through the inside of the user's face through a microphone embedded in an earphone or earset, it is possible to set and input a password through the user's own biometric recognition. In this case, the login authentication of an electronic wallet may be more intuitively and naturally performed, compared to the case where the user wears an earphone or earset, and since the user's own biometric recognition is not the recognition of a voice signal transmitted to the outside, it is difficult to hack information and thus security may be increased.

Next, in the remitter and collector account 210, a private key is generated (Operation S520), and a public key is generated based on the private key and an address of the electronic wallet may be generated (Operation S530). The address of the electronic wallet may be generated by hashing the public key, or may be generated without using the public key through another method. The pair of the private key and the public key generated in this way may be stored in the electronic wallet.

Next, metadata mapped to the address of the electronic wallet may be generated and processed (Operation S540). The remitter and collector account 210 may generate metadata mapped to or corresponding to the address thereof through the verification process of an official node or the verification process of a nonofficial node, which are described above, and the generated metadata serves as an index, thereby enabling keyword search of the address of the electronic wallet.

Accordingly, keyword search using metadata mapped to the address of the electronic wallet is provided (Operation S550), and thus the user may solve the problem of difficulty in reading due to a complex address of the electronic wallet and may conveniently search the address of the electronic wallet as in the case of web keyword search. In addition, as a result of keyword search, information related to metadata of an official node and information related to metadata of a nonofficial node may be displayed to be distinguished from each other, and thus the user who is the search subject may trust the official node in search results.

Next, the user may more conveniently perform remittance and collection by using the address of the electronic wallet searched through keyword search (Operation S560).

According to one or more embodiments described above, provided may be a blockchain-based remittance and collection method, by which an electronic wallet address or a smart contract address is easily found through keyword search and which has user convenience, reliability, and security, and a system using the blockchain-based remittance and collection method.

According to one or more embodiments described above, provided may be a blockchain wallet platform that may easily find an electronic wallet address or a smart contract address through a keyword search function and may maintain the reliability of a search database.

A blockchain-based remittance and collection platform according to one or more embodiments described above may contribute to related network activation by resolving information asymmetry and information gaps between collectors and remitters in a blockchain-based remittance and collection platform.

According to one or more embodiments described above, provided may be a blockchain-based remittance and collection method and system using keyword search, which may activate a remittance and collection network between music creators or related stakeholders and multinational fans, or between multinational fans.

The above effects are not limited to the above-mentioned contents, and other effects not mentioned will be clearly understood from the detailed description given above.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. A blockchain-based remittance and collection system using keyword search, the blockchain-based remittance and collection system comprising:
a remitter and collector node that executes a remitter and collector account including an address generator configured to generate an address and a metadata generator configured to generate metadata mapped to the address; and
a verification node including an address mapping processor configured to map metadata to an address of the remitter and collector account,
wherein the remitter and collector account is one of an electronic wallet and a smart contract.

2. The blockchain-based remittance and collection system of claim 1, wherein the verification node further includes:
a verification processor configured to verify whether a condition for snapping the metadata to the address of the remitter and collector account is satisfied; and
a keyword search processor configured to search for an address of at least one remitter and collector account through keyword search.

3. The blockchain-based remittance and collection system of claim 2, wherein the metadata includes at least one piece of hashtag information generated in association with the remitter and collector account.

4. The blockchain-based remittance and collection system of claim 2, wherein the verification processor maps metadata to an account address of an official node through proof, and the verification of the official node is based on a hierarchy structure.

5. The blockchain-based remittance and collection system of claim 4, wherein the verification processor determines whether to map information associated with the metadata of the official node to an account address of a nonofficial node based on whether a past transaction exists between the nonofficial node and the official node.

6. The blockchain-based remittance and collection system of claim 4, wherein the verification node further includes a metadata display processor configure to display information associated with the metadata of the official node and information associated with metadata of a nonofficial node to be different from each other when keyword search of the address of the remitter and collector account is performed.

7. The blockchain-based remittance and collection system of claim 1, further comprising a substitute remitter account designated in association with the remitter and collector account,
wherein, when a substitute remittance is requested by the remitter and collector account, at least a portion of a remittance amount is remitted from the substitute remitter account.

8. The blockchain-based remittance and collection system of claim 1, wherein a password for the remitter and collector account is set through recognition of sound received through an inside of an ear in an earphone mounted on a user of the remitter and collector account.
